(19) United States
(12) Patent Application Publication
(10) Pub. No.: US 2016/0050508 A1
(43) Pub. Date: Feb. 18, 2016

(54) METHOD FOR MANAGING REVERBERANT FIELD FOR IMMERSIVE AUDIO

(71) Applicants: William Gebbens REDMANN, Glendale, CA (US); THOMSON LICENSING, Issy Les Moulineazux (FR)

(72) Inventor: William Gibbens Redmann, Glendale, CA (US)

(21) Appl. No.: 14/782,335

(22) PCT Filed: Jul. 25, 2013
(86) PCT No.: PCT/US13/51929

§ 371 Date: Oct. 5, 2015

Related U.S. Application Data
(60) Provisional application No. 61/808,709, filed on Apr. 5, 2013.

(51) Int. Cl. H04S 7/00

(52) U.S. Cl. CPC H04S 7/302; H04S 2400/11

(57) ABSTRACT

A method for reproducing, in an auditorium, audio sounds in an audio program commences by examining audio sounds in the audio program to determine which sounds are precedent and which sound are consequent (e.g., a gunshot and its ricochet). The precedent and consequent audio sounds undergo reproduction by sound reproducing devices in the auditorium, wherein the consequent audio sounds undergo a delay relative to the precedent audio sounds in accordance with distances from sound reproducing devices in the auditorium so audience members will hear precedent audio sounds before consequent audio sounds.

### CROSS-REFERENCE TO RELATED APPLICATIONS

This application claims priority under 35 U.S.C. 119(e) to U.S. Provisional Patent Application Ser. No. 61/808,709, filed Apr. 5, 2013, the teachings of which are incorporated herein.

### TECHNICAL FIELD

This invention relates to a technique for presenting audio during exhibition of a motion picture.

### BACKGROUND ART

When mixing and editing a soundtrack for a motion picture film, a sound engineer who performs these tasks wants to create an enjoyable experience for the audience who will later watch that film. In many cases, the sound engineer can achieve this goal with impact by presenting an array of sounds that cause the audience to feel immersed in the environment of the film. In an immersive sound experience, two general scenarios exist in which a first sound has a tight semantic coupling to a second sound in such a way as they must appear in order, e.g., within about 100 mS of each other: First, individual audio elements can have a specific arrangement relative to each other in time (e.g., a gunshot sound immediately followed by a ricochet sound). Often, such sounds can have discrete positions in space (e.g., a gunshot from the cowboy appears to originate on the left, and a subsequent ricochet appears to emanate near a snake to the right). This effect can occur by directing the sounds to different speakers. Under such circumstances, the gunshot will precede the ricochet. Therefore, the gunshot becomes “precedent” to the ricochet which becomes “consequent.”

A second instance of tight sound coupling can occur during instances when sound production occurs other than on the movie set, such as during dubbing (i.e., re-recording dialog at a later date) and during creation of Foley effects. In order for the sounds created in this manner to appear convincing enough for an audience not to doubt that the sounds originated in the scene being portrayed, the sound engineer will generally augment such sounds by adding reflections (e.g., echoes) and/or reverberation. Sounds recorded in the field can include the reverberation present in the actual situation. For a sound recorded in a studio to match those recorded on the movie set, such augmentation becomes necessary to provide subtle, even subconscious, hints that the sound comes from within the scene, rather than the reality of its completely dissimilar origin. In many cases, absent this augmentation, the character of the sound by itself can alert the audience of its artificiality, thus diminishing the experience. By virtue of its nature, a reflection/echo/reverberation becomes the consequent sound for the corresponding to the precedent sound.

During production of the soundtrack, the sound engineer sits at a console in the center of a mixing stage, and has the responsibility for arranging the individual sounds (including both precedent and consequent sounds, sometimes referred to herein as “precedents” and “consequents”, respectively) in time. In addition, the sound engineer also has responsibility for arranging the sounds in space when desired, e.g., panning a gunshot to a speaker at the screen, and the ricochet to a speaker at the back of the room. However, a problem can emerge when two sounds with a tight semantic coupling play out on different speakers: The soundtrack created by the sound engineer assumes a standard motion picture theater configuration. However, the soundtrack, when later embodied in motion picture film (including digital distributions), will undergo distribution to a large number of theaters having different sizes.

In most instances, most audience members sit near the center of the theater, as did the sound engineer. For the sake of a simplicity, consider the following example in which the a sound engineer sits between the screen and speakers at the back of the room while creating created a soundtrack where, to the sound engineer, a precedent gunshot at the screen is heard first, followed by a consequent ricochet sound from the back of the mixing stage some 20 mS later. Compare this to the experience of an audience member sitting one row further back of the center of the theater where the sound engineer sat. As a rough approximation, sound travels at approximately 1 foot/mS, so that for every row further back the audience member sits (at approximately 3 feet/row), the audience member will hear sound from the screen 1 mS later, and sound from the back of the room 1 mS sooner. Thus, an audience member sitting further back from the center of the theater by just one row will hear the consequent approximately 6 mS sooner, relative to the precedent sound because the audience member lies closer to the rear speaker and further from the front speaker. If an audience member sits back five rows, that audience member's seating position has introduced a 30 mS differential delay between the precedent and consequent sounds, enough that the audience member sitting in that position here now hears a ricochet 10 mS before hearing a gunshot.

According to psychoacoustic principle known as the “Haas Effect,” when the same or similar sounds emanates from multiple sources (either two identical copies of a sound or e.g., a precedent sound and its consequent reverb), the first sound heard by a human listener establishes the perceived direction of the sound. Because of this effect, the spatial placement of precedent sounds intended by the sound engineer could suffer from significant disruption for audience members sitting close to speakers delivering consequent sounds. The Haas Effect can cause some audience members to perceive the origin of the precedent sound as the source of the consequent sounds. Generally, the sound engineer does not have an opportunity to adequately take account of theater seating variations. Rarely can a sound engineer take the time to move around the mixing stage and listen to the soundtrack at different locations. Moreover, if the sound engineer did so, then the mixing stage would no longer represent larger or even most typically-sized theaters. Thus, the spatial placement of precedent sounds by the sound engineer may not translate correctly for all seats in a mixing stage and may not translate for all the seats in a larger theater.

Modern surround sound systems for wide theatrical distribution (as opposed to experimental, dedicated mixers for specific venues) first appeared in the late 1970's, providing multiple speakers located at the screen, and surround speakers located in the rear of the theater A delay line for the rear speakers of “75% of the sound path length from the front to rear of the auditorium” became the recommended standard for such sound systems (Allan, UK Patent 2,006,583 filed 10 Oct. 1978). For more modern configurations, the advice has become more specific. The program for the surround speakers should undergo a delay by not less than an amount of time corresponding to the difference between the shortest surround sound path length to the furthest-back corner seat and the sound path length from that seat to the furthest screen speaker.

This practice of delaying the surround channels by a specific amount addresses the Haas Effect for precedent sounds on the screen speaker channels (also known as the “mains”) with respect to consequent sounds on the surround channels (also known as the “surrounds”). (Alternatively, placing consequent sounds behind the precedent sounds in the soundtrack timeline also will help alleviate the risk of consequent sounds playing on the surrounds inducing a perception by audience members sitting near to the surrounds that the corresponding precedent sound originated from the sides or back of the theater, but such a practice must make certain assumptions about the theatre configuration and for a given offset will only work up to a certain size theatre). Unfortunately, the practice of delaying audio to the surround channels does not work for precedent sounds other than those emanating from the mains, or for consequent sounds other than on the surrounds.

International Patent Application WO 2013/006330, filed 10 Jan. 2013 and assigned to Dolby Laboratories Licensing Corporation, entitled “System and Tools for Enhanced 3D Audio Authoring and Rendering” by Tsingos et al. teaches the basis of the “Atmos” audio system marketed by Dolby Laboratories, but does not address the aforementioned problem of having audience members mis-perceive the source of precedent and consequent sounds. IOSONO, GmbH of Erfurt, Germany, along with other companies, now promote a wave front synthesis paradigm, wherein a dense array of speakers surrounds the audience, and for each sound, a plurality of speakers having a facing to support the propagation of the sound will each reproduce exact copies of the audio signal representing the sound. Each speaker will generally have a slightly different delay computed on the basis of Huygens' Principle wherein each speaker emits the audio signal with a phase delay based on how much closer that speaker is to the sound's virtual position than the furthest speaker of the plurality. These delays will generally vary for each sound position. The wave front synthesis paradigm demands this behavior of the speakers but only considers the position of the one sound: Such systems do not readily handle two distinct sounds having a precedent/consequent relationship.

### BRIEF SUMMARY OF THE INVENTION

In an audio program, two sounds can have a relationship as precedent and consequent, for example, gunshot and ricochet, or direct sound (first arrival) and reverberant field (including the first reflection). Briefly, in accordance with a preferred embodiment of the present principles, a method for reproducing, in an auditorium, audio sounds in an audio program commences by examining audio sounds in the audio program to determine which sounds are precedent and which sound are consequent. The precedent and consequent audio sounds undergo reproduction by sound reproducing devices in the auditorium, wherein the consequent audio sounds undergo a delay relative to the precedent audio sounds in accordance with distances from sound reproducing devices in the auditorium so audience members will hear precedent audio sounds before consequent audio sounds.

### BRIEF DESCRIPTION OF THE DRAWINGS

FIG. 1 depicts an exemplary a floor plan, including speaker placement, for a mixing stage where an immersive soundtrack preparation and mixing occurs;

FIG. 2 depicts an exemplary a floor plan, including speaker placement, for a movie theater where the immersive soundtrack undergoes playout in connection with exhibition of a motion picture;

FIG. 3 depicts an imagined scenario for a motion picture set, including camera placement, in connection with rendering of the immersive soundtrack;

FIG. 4A depicts a portion of an exemplary user interface for a soundtrack authoring tool for managing for managing consequent sounds as independent objects in connection with mixing of the immersive soundtrack;

FIG. 4B depicts a compacted exemplary representation for the sounds managed in FIG. 4A;

FIG. 5A depicts a portion of an example user interface for a soundtrack authoring tool for managing consequent sounds as one or more collective channels in connection with mixing the immersive soundtrack;

FIG. 5B depicts a compacted exemplary representation for the sounds managed in FIG. 5A;

FIG. 6 depicts in a flowchart form an exemplary process for managing consequent sounds while authoring and rendering an immersive soundtrack;

FIG. 7 depicts an exemplary portion of a set of multiple data files for storing a motion picture composition having picture and an immersive soundtrack, including metadata descriptive of consequent sounds;

FIG. 8 depicts an exemplary portion of a single data file, representing the immersive audio track, suitable for delivery to theatre;

FIG. 9 depicts a diagram showing an exemplary sequence for a sound object over the course of a single frame; and,

FIG. 10 depicts a table of metadata comprising entries for the positions of the sound object of FIG. 9, for interpolating those entries, and for flagging consequent sound object.

### DETAILED DESCRIPTION

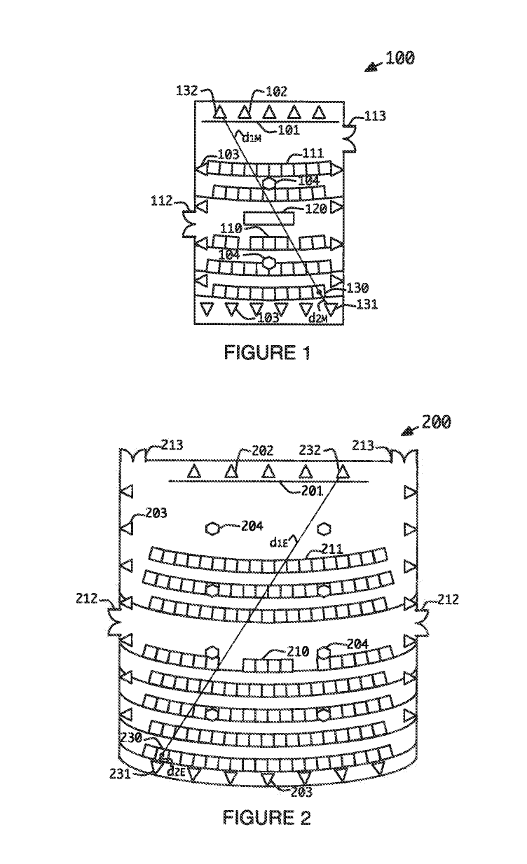

FIG. 1 depicts a mixing stage 100 of the type where mixing of an immersive soundtrack occurs in connection with post-production of a motion picture. The mixing stage 100 includes a projection screen 101 for displaying the motion picture while a sound engineer mixes the immersive audio on an audio console 120. Multiple speakers (e.g., speaker 102) reside behind the projection screen 101 and additional multiple speakers (e.g., speaker 103) reside at various locations around the mixing stage. Further one or more speakers, (e.g., speaker 104) can reside in the ceiling of the mixing stage 100 as well.

Personnel, such as the sound engineer, gain primary access to mixing stage 100 through a set of doors 112. A second set of doors 113 to the mixing state 100 provide additional access, typically for the purpose of providing an emergency, exit. The mixing stage 100 includes seating in the form of seating rows, e.g., those rows containing seats 110, 111, and 130, which allow individuals occupying such seats to view the screen 101. Typically, gaps exist between the seats to accommodate one or more wheelchairs (not shown).

The mixing stage 100 has a layout generally the same as a typical motion picture theater, with the exception of the mixing console 120, which allows one or more sound engineers seated in seating row 110 or nearby, to sequence and mix audio sounds to create an immersive soundtrack for a motion picture. The mixing stage 100 includes at least one seat, for example seat 130, positioned such that the worst-case difference between the distance d_{1M} to the furthest speaker 132 and the distance d_{2M} to the nearest speaker 131 has the greatest value. Usually although not necessary, the seat having the worst-case distance difference resides in a rearmost corner of the mixing stage 100. Due to lateral symmetry, the other rearmost corner seat will often also have the greatest worst-case difference between the furthest and nearest speakers. The, worst-case difference, hereinafter referred to as “the differential distance” (δd_{M}) for the mixing stage 100 is given by the formula δd_{M}=d_{M1}−d_{M2}. The differential distance δd_{M} will depend on the specific mixing stage geometry, including the speaker positions and seating arrangement.

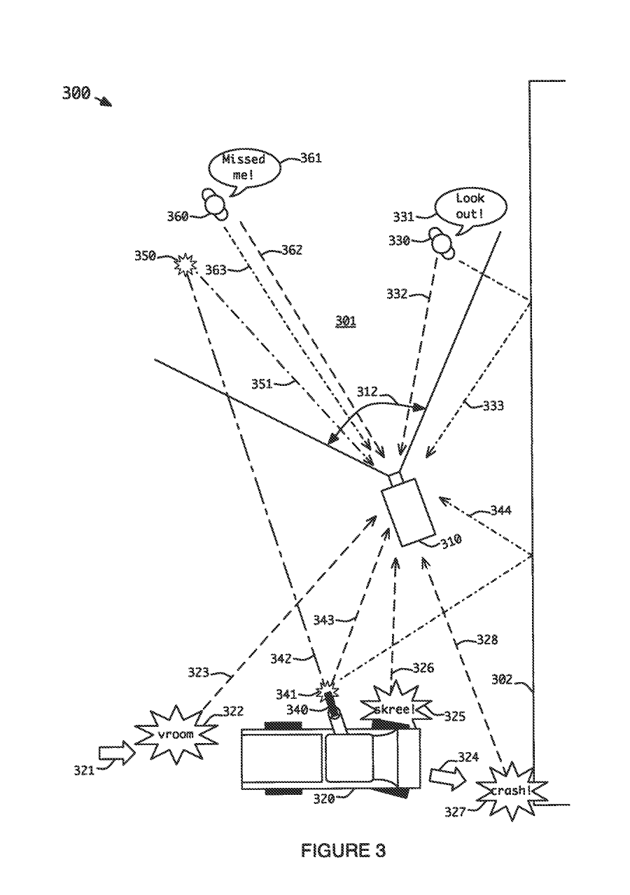

FIG. 2 depicts a theater 200 (e.g., an exhibition auditorium or venue) of the type designed for exhibiting motion pictures to an audience. The theater 200 depicted in FIG. 2 has many features in common with the mixing stage 100 of FIG. 1. Thus, the theater 200 has a projection screen 201, with multiple speakers behind the screen 201 (e.g., speaker 202), multiple speakers around the room (e.g., speaker 203), as well as speakers in the ceiling (e.g., speaker 204). The theater 200 has one or more primary entrances 212 as well as one or more emergency exits 213. To accommodate moviegoers, the theater has many seats, exemplified by seats 210, 211, and 230. Seat 210 resides nearly at the center of the theater.

The geometry and speaker layout of the theater 200 of FIG. 2 typically differs from that of the mixing stage 100 of FIG. 1. In this regard, the theater 200 typically has a different differential distance δd_{E} given by the formula δd_{E}=(d_{E1}−d_{E2}), where d_{E1} constitutes the distance from the seat 230 to speaker 232, and d_{E2} constitutes the distance from the seat 230 to the speaker 231. The seat to the left of the seat 230 lies marginally further from the speaker 232 and lies differentially further still from the speaker 231. Thus for the theater 200 having the configuration depicted in FIG. 2, the seat 230 has the worst-case differential distance (which in this example is more or less reproduced by the back-row seat having the opposite laterally symmetrical position).

The number of speakers, their arrangement and spacing within each of mixing stage 100 and theater 200 represents two of many possible examples. However, the number of speakers, their arrangement and spacing does not play a critical role in reproducing precedent and consequent audio sounds in accordance with the present principles. In general, more speakers, with more uniform and smaller spaces between them, make for a better immersive audio environment. Different panning formulae, with varying diffuseness, can serve to vary impressions of position and distinctness.

Referring to FIG. 1, without concern for distance to the seat 130, a sound engineer, working in the mixing stage 100 while seated in seat 110, can produce an immersive soundtrack, which when played back, in many cases, will sound substantially similar and satisfying to a listener in seat 210 or in another seat nearby in the theater 200. To a significant extent, the centrally the located seat 110 in the mixing stage 100 lies approximately the same distance from opposing speakers in the mixing stage, and likewise the distance between the centrally located seat 210 in the theater 200 of FIG. 2 and opposing speakers in that venue are approximately symmetrical, thus giving rise to such a result. However, where theaters exhibit different front-to-back length to side-to-side width ratios, even central seats 110 and 120 can exhibit differences in performance when it comes to precedent and consequent sounds.

The centrally located seats in the mixing stage 100 and the theater 200 of FIGS. 1 and 2, respectively, (e.g., seats 110 and 210, respectively) have a smaller differential distance between any two speakers than for the worst-cases at seats 130 and 230, respectively. As a result, the inter-speaker delay as experienced by a listener in the centrally located seats, appears reasonably small, but gets worse the farther the seat lies from the central location. Assuming a distance of approximately 36″ between the rows of seats in both the mixing stage 100 and the theater 200, then the differential distance δd_{M} becomes about 21′ and δd_{E} becomes about 37′. Assuming that sound travels approximately 1 foot per millisecond, then for worst-case seat 130 in the in mixing stage 100 of FIG. 1, sounds emitted simultaneously from the front speaker 132 and rear speaker 131 will arrive 21 mS apart (with the sound from the rear speaker 131 arriving first). Referring to FIG. 2, at worst-case seat 230 in the mixing stage 200 of FIG. 2, sounds emitted simultaneously from the front speaker 232 and the rear speaker 231 arrive 37 mS apart (again, with the sound from rear speaker 231 arriving first). Thus, for these seats, sound from front speakers 132 and 232 in the mixing state 100 and the theater 200, respectively, arrive later the sounds from rear speakers 131 and 231, respectively, in these facilities, because the sound must travel further, as measured by the differential distance.

Generally, this time-of-flight for sounds from more-distant speakers does not constitute a major issue. However, if two sounds being emitted comprise the same sound, an audience member sitting in these worst-case seats will typically perceive that the nearby speaker constitutes the original source of these sounds. Likewise, if the two sounds emitted comprise as precedent and consequent, as with a first sound and its reverberation, or as with two distinct, but related sounds (e.g., a gunshot and a ricochet), the sound that arrives first will typically define the location perceived as the source of the precedent sound. In either case, the listener's perception as to the source will prove problematic if the more distant speaker was intended to be the origin of the sound, as the time-of-flight induced delay will cause the perceived origination to be the nearer speaker.

While mixing on the console 120 from the seat 110 of FIG. 1, the sound engineer will not perceive this problem. Even if the sound engineer sat in the seat 130 and mixed from there (whether by remote control or by moving the console 120), or at least assess the mix from that seat, the judgment of a satisfactory result would only extend to worst-case seating in theaters with a worst-case differential distance no greater than that for the mixing stage 110 (i.e., where δd≦δd_{M}). Even so, most sound engineers do not undertake such effort. Production schedules are too tight and personnel too pressed for time to test the extreme seating positions.

Classically, for soundtracks that employed surround sound, that is, where the ranks of speakers (e.g., the speaker 103) around the back and sides of the room undergo division into one, two, or three groups each corresponding to a particular audio surround channel, as distinguished from the channels associated with the individual speakers (e.g., speaker 102) behind the screen, the surround channels would all undergo a delay by an amount of time derived from the theatre's geometry, by various formulae, all of which rely on a measured or approximated value for δd. In cases of matrixed systems, with the surround channels encoded onto other audio channels, the differential distance δd (or its approximation) will have an additional amount added to accommodate crosstalk from the imperfect separation of channels to which matrixed systems are prone. As a result, a theater, like theater 200 of FIG. 2 would delay its surround channels by about 37 mS, while the mixing stage 100 of FIG. 1 would delay its surround channels 100 by about 21 mS. Such settings would ensure that, as long as sounds obeyed a strict temporal precedence in the soundtrack, and all the precedent sounds originated from the screen speakers (e.g., speakers 102 and 202 of FIGS. 1 and 2 respectively), no situation would arise where a sound appears to originate from the surrounds instead of the screen. In an immersive sound system, delaying the surround sound channels (i.e., the audio channels not on-screen) will not prove an adequate solution since precedent sounds can originate off-screen, some of which have corresponding consequent sounds placed elsewhere, whether on the screen or not.

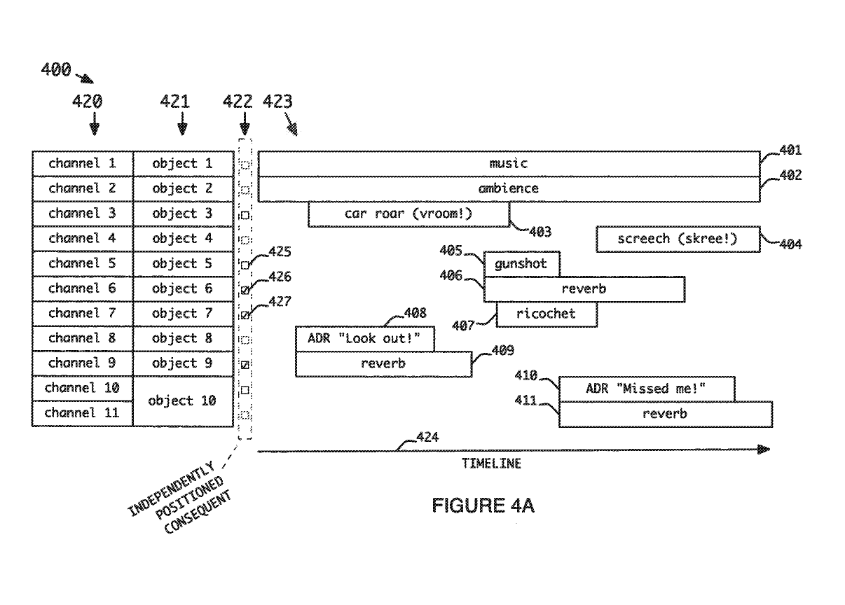

FIG. 3 depicts an imagined scene 300 for a motion picture set, including a camera placed at a camera position 310. Assuming the scene 300 represented an actual motion picture set during filming; a number of sounds would likely originate all around the position of the camera 310. Assuming recording of the scene as it played out, or sound engineer received the off-camera (or even on-camera) sounds separately, the sound engineer would then compile the sounds into an immersive soundtrack.

As depicted in FIG. 3, the scene 300 takes place in a parking lot 301 adjacent to a building 302. Within the scene 300, two people 330 and 360 stand within the field-of-view 312 of a camera 310. During this scene, a vehicle 320 (off camera) will approach a location 321 in the scene so that the sound 322 of the vehicle engine (“vroom”) now becomes audible. The approach of the vehicle prompts the first person 330 to shouts a warning 331 (“Look out!”). In response, the driver of the vehicle 320 fires a gun 340 from the vehicle in a direction 342, producing gunshot noise 341 and ricochet sound 350. The second person 360 shouts a taunt 361 (“Missed me!”). The driver of vehicle 320 swerves to avoid building 302 and skids in a direction 324, producing screech sound 325 and eventually a crash sound 327.

In the course of building the immersive soundtrack for such a scene, a sound editor may choose to provide some reverberant channels to represent sound reflections off large surfaces for some of the non-diffuse sounds. In this example, the sound engineer will choose to have the audience hear the warning 331 by a direct path 332, but also by a first-reflection path 333 (bouncing off the building 302). The sound engineer may likewise want the audience to hear the gunshot 341 by a direct path 343, but also by a first-reflection path 344 (also off building 302). The sound engineer could independently spatialize each of these reflections (i.e., move the reflected sound to different speakers than the direct sound). However, the audience should hear the taunt 361 by a direct path 362, but also by a first-reflection path 363 (off of the parking lot surface). Thus, the reflection arrives delayed with respect to the taunt 361 heard via the direct path 362, but the reflection should come from substantially the same direction (i.e., from the same speaker or speakers). As part of the creative process associated with mixing the immersive soundtrack, the sound engineer can choose not to provide reverb for certain sounds, such as the engine noise 322, the screech 325, the crash 327, or the ricochet 350. Rather, the sound engineer can treat these sounds individually as spatialized sound objects having direct paths 323, 326, 328, and 351, respectively. Further, the sound engineer can treat the engine noise 322 and screech 325 as traveling sounds, since the vehicle 320 moves, so the corresponding sound objects associated with the moving vehicle would have a trajectory (not shown) over time, rather than just a static position.

Depending on the nature and implementation of a particular immersive sound technology, spatial positioning controls may allow the sound engineer to position the sounds by one or more different representations, which may include Cartesian and polar coordinates. Not by way of limitation, consider the following examples of possible representations for spatial positioning of audio objects:
Sounds might lie strictly in a substantially horizontal plane (i.e., a 2D positioning), for example using any of these representations:
   a_{2D}) as an {x,y} coordinate (e.g., with the center of the theatre being {0,0} and the unit distance scaling with to the distance from the central seats, e.g., 110, 210, to the screen, so that the center of the screen is at {1,0}) and the center rear of the auditorium is at {−1,0});
   b_{2D}) as strictly an azimuth angle {θ} (e.g., with the central seats 110, 210 of the theatre being the origin and zero degrees (0°) being toward the center of the screen), thus sounds are placed on a circle centered about the middle of the theatre or other predetermined center; or,
   c_{2D}) as an azimuth angle and range {θ,r}, which is a different representation for placements in the horizontal plane.
Alternatively, sounds could lie in three-dimensional space, for example using any of these representations:
   a_{3D}) as an {x,y,z} coordinate;
   b_{3D}) as an azimuth angle and elevation angle {θ,Φ}, allowing positioning of sounds on a sphere centered at the middle of the theatre or other predetermined center; or,
   c_{3D}) as an azimuth angle, elevation angle, and range {θ,Φ,r}.

Representations of semi-three-dimensional sound positions can occur using one of the two-dimensional versions, plus a height coordinate (which is the relationship between a_{2D} and a_{3D}). However, in some embodiments, the height coordinate might only take one of a few discrete values, e.g., “high” or “middle”. Representations such as b_{2D} and b_{3D} establish only direction with the position being further determined as being on a unit circle or sphere, respectively, whereas the other exemplary representations further establish distance, and therefore position.

Other representations for sound object position could include: quaternions, vector matrices, chained coordinate systems (common in video games), etc, and would be similarly serviceable. Further, conversion among many of these representations remains possible, if perhaps somewhat lossy (e.g., when going from any 3D representation to a 2D representation, or from a representation that can express range to one that does not). For the purpose of the present principles, the actual representation of the position of sound objects does not play a crucial role during mixing, nor when an immersive soundtrack undergoes delivery, or with any intervening conversions used during the mixing or delivery process.

By way of example, Table 1 shows a representation for the position of sound objects possibly provided for the scene 300 illustrated in FIG. 3. The representation of position in Table 1 uses system b_{2D} from above.

TABLE 1
Azimuth of Sound Objects from Scene 300

| | Position {azimuth θ} |
|---|---|
| Sound Object | (relative to facing of camera 310) |
| Engine Noise 322 | −115° (moving) |
| Warning shout 331 | 30° |
| Echo of Warning Shout 331 | 50° |
| (along 333) | |
| Gunshot 341 | −140° |
| Echo of Gunshot 341 (along 344) | 150° |
| Ricochet 350 | −20° |
| Screech 325 | −160° (moving) |
| Taunt 361 (along 362) + | −10° |
| Echo of Taunt 361 (along 363) | |
| Crash 327 | −180° |

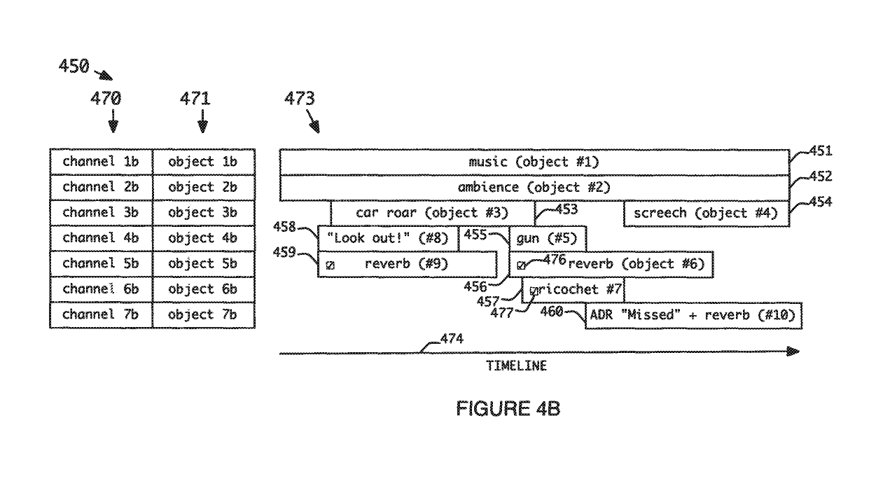

FIG. 4A shows an exemplary user interface for a soundtrack authoring tool used by a sound engineer to manage a mixing session 400 for the scene 300 of FIG. 3 in which the column 420 of FIG. 4A identifies eleven rows, each designated as a “channel” (channels 1-11) for each of the eleven separate sounds in the scene. In some situations, a single channel could include more than one separated sound, but the sounds sharing a common channel would occupy distinct portions of the timeline (not shown in FIG. 4A). The blocks 401-411 in FIG. 4A identify the specific audio elements for each of the assigned channels, which elements could optionally appear as a waveform (not shown). The left and right ends of blocks 401-411 represent the start and end points respectively, for each audio element along the timeline 424, which advances from left to right. Note that the duration of items along a timeline (e.g., timeline 424) throughout this document, are not shown to scale and, in particularly, the elements have been compressed, in some cases unevenly, so as to fit, yet still clearly illustrate the present principles.

In column 421, the separate sounds (by way of their channels) correspond to assigned objects 1-10. The sound engineer can individually position the sound objects in column 421 in an acoustic space by giving each object a 2D or 3D coordinate, for example, in one of the formats described above (e.g., the azimuth values in Table 1). The coordinate can remain fixed, or can vary over time. In some cases, as the image on the movie screen (e.g., screens 101 and 201 of FIGS. 1 and 2, respectively) shifts due to movement (not shown) of the camera 310 in FIG. 3, updating of the position of all or most of the sound objects typically will occur to maintain their position in the scene, relative to the field-of-view of the camera. Thus, if the camera were to turn 90° clockwise, the sounds would rotate around the auditorium 90° counterclockwise, so that a sound, e.g., the taunt 361, previously on the screen, after the camera move, now emanates from an appropriate location on the left-wall of the auditorium.

The audio element 401 of FIG. 4A contains the music (i.e., score) for the scene 300 of FIG. 3. In some cases, the sound engineer can separate the score into more than one channel (e.g., stereo), or with particular instruments assigned to individual objects, e.g., so the strings might have separate positions from the percussion instruments (not shown). The audio element 402 contains general ambience sounds, e.g., distant traffic noise, that does not require an individual call-out. As with the music in the audio element 401, the ambience track might encompass more than a single channel, but would generally have a very diffuse setting so as to be non-localizable by the listening audience. In some embodiments, the music channel(s) and ambience channel(s) can have objects (e.g., object 1, object 2, as shown in FIG. 4A) where the objects have settings suitable for the desired sound reproduction. In other embodiments, the sound engineer could pre-mix the music and ambience for delivery on specific speakers (e.g., the music could emanate from the speakers behind the screen, such as speakers 102 and 202 of FIGS. 1 and 2, respectively, while ambience could emanate from the collection of speakers surrounding the auditorium (e.g., the speakers 103 and 203 of FIGS. 1 and 2, respectively), independent of static or dynamic coordinates. Whether this latter embodiment employs the sound-object construct where special objects are predetermined to render audio to specific speakers or speaker groups, or whether the sound engineer manually provides a traditional mix to a standard 5.1 or 7.1 constitutes a matter of design choice or artistic preference.

The remaining audio elements 403-411 each represent one of the sounds depicted in scene 300 of FIG. 3 and correspond to assigned sound objects 3-10 in FIG. 4A, where each sound object has a static or dynamic coordinate corresponding to the position of the sound in the scene 300. In FIG. 4A, the audio element 403 represents the audio data corresponding to the engine noise 322 of FIG. 3 (assigned to object 3). Using the coordinate system b_{2D} above, the object 3 has a coordinate of about {−115°} (from Table 1), and that coordinate will change somewhat, because the engine noise object 322 will move with the moving vehicle 320 of FIG. 3. The audio element 404 represents the screech 325, and corresponds to assigned object 4. This object will have a coordinate of about {−160°}. The screech 325, like the engine noise 322, also moves. The audio element 405 represents the gunshot 341 of FIG. 3 and corresponds to assigned object 5 having a static coordinate {−140°}, whereas the audio element 406 comprises reverb effect derived from audio element 405 to represent the echo of the gunshot 341 of FIG. 3 heard by the reflective path 344. The audio element 405 corresponds to assigned object 6 having static coordinate {150°}. Because the reverberation effect used to generate audio element 406 employs feedback, the reverberation effect can last substantially longer than the source audio element 405. The audio element 407 represents the ricochet 350 corresponding to gunshot 341. The audio element corresponds to assigned object 7 having a static coordinate {−20°}.

The audio element 408 on channel 8 represents the shout 331 of FIG. 3 and corresponds to assigned object 8 having static coordinate {30°}. The sound engineer will provide the audio element 409 for the echo of the shot 331, which appears to arrive on the path 333, as a reverb effect on channel 9 derived from the audio element 408. Channel 9 corresponds to the assigned sound object 9 with a static coordinate of {50°}. Lastly, the audio element 410 on channel 10 contains the taunt 361, whereas the audio element 411 contains the echo of taunt 361, derived from the audio element 410 after processing with a reverb effect and returned to channel 11. Since the direction of both taunt 361 and its echo lie along substantially similar paths 362 and 363, the sound engineer can assign the two audio elements 410 to the common sound object 10, which in this example would have a static position coordinate of {−10°}, illustrating that in some cases, the sound engineer can assign more than one channel (e.g., channels 10, 11) to a single sound object (e.g., object 10).

In column 422 of FIG. 3, an exemplary user interface, in the form of a checkbox, provides a mechanism for the sound engineer to designate whether a channel represents a consequent of another channel, or not. The unmarked checkbox 425, corresponding to channel 5 and audio element 405 for gunshot 341, designates that audio element 405 does not constitute a consequent sound. Conversely, the marked checkboxes 426 and 427, corresponding to channels 6 and 7, respectively, and audio elements 406 and 407, respectively, for the echo of the gunshot 341 and the ricochet 350, respectively, designate that the audio elements 406 and 407 constitute consequent sounds. Likewise, the sound engineer will designate channel 9 as a consequent sound.

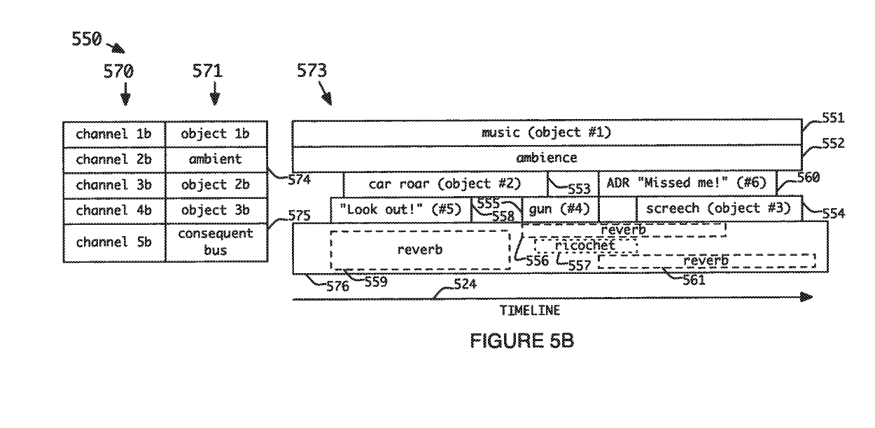

Designating such sounds as consequent and delivering this designation as metadata associated with the associated channel(s), object(s), or audio element(s) has great importance during rendering of the soundtrack as described in greater detail with respect to FIG. 6. Designating a sound as a consequent will serve to delay the consequent sounds relative to the rest of the sounds by an amount of time based on the worst case differential distance (e.g., δd_{M}, δd_{E}) in the particular venue (e.g., mixing stage 100 and theater 200) in connection with soundtrack playback. Delaying the consequent sounds prevents any differential distance within the venue from causing any audience member to hear a consequent sound in advance of the related precedent sound. Note that in this example embodiment, the corresponding precedent for a particular consequent (and vice versa) is not noted, though in some embodiments (discussed below) noting the specific precedent/consequent relationship is needed. In some cases, for example where the derivation of a channel (e.g., 406, 409) can be known by the system to come from another channel (e.g., 405, 408, respectively), the designation of being a consequent may be automatically applied.

As a particular example, consider the gunshot 341 of FIG. 3, represented by the audio element 405 of FIG. 4A, and rendered in the theater 200 of FIG. 2 based on the static coordinate of {−140°} ascribed to object 5, at or near the rear speaker 231. The gunshot 341 constitutes the precedent of both the echo represented by the audio element 406 and the ricochet represented by the audio element 407. As a precedent sound, or a sound other than a consequent sound, the audio element 405 representing the gunshot 341 will have an unmarked checkbox 425 (so the audio element does not get considered as a consequent sound). The sound engineer will designate both the echo 406 and the ricochet 407 as consequent sounds by marking the checkboxes 426 and 427, respectively. In some embodiments, the precedent/consequent relationship between audio elements 405 and 406 and 405 and 407 might be noted (not shown), rather than merely indicating that elements 406 and 407 are consequents. No requirement exists to note a relationship between a precedent and consequent other than to provide a warning (not shown) if, for example, the ricochet audio element 407 were placed in advance (not shown) of the gunshot audio element 405 along the timeline 424.

During exhibition of a movie (and the corresponding playout of the associated soundtrack in the theater 200, each of the audio elements tagged as consequent sounds (e.g., by a marked checkbox) will undergo a delay by a time corresponding to about δd_{E}, because δd_{E} constitutes the worst-case differential distance in theater 200, and that delay is long enough to ensure that any member of the audience in theater will not hear a consequent sound in advance of its corresponding precedent.

In other embodiments, the audio processor (not shown) that controls each speaker or speaker group in a venue, such as the theater 200 of FIG. 2, could have a preconfigured value for the worst case differential distance (δd) with respect to that speaker, or the corresponding delay, such that any consequent sound selected for reproduction through a particular speaker would undergo the corresponding delay, but non-consequent sounds would not get delayed, thereby ensuring that consequents reproduced by that speaker could not be heard by any audience member in the theater before the corresponding precedent, regardless of from which speaker reproduced the precedent. This arrangement offers the advantage of reducing the delay imposed on consequents played from some speakers.

In still other embodiments, the audio processor (not shown) that controls each speaker or speaker group in a venue could have a preconfigured value for the differential distance of that speaker (or speaker group) with respect to each other speaker (or other speaker group), or the corresponding delay, such that any consequent sound selected for reproduction through a particular speaker would undergo the delay corresponding to that speaker (or speaker group) and the speaker (or speaker group) on which is playing the corresponding precedent sound, thereby ensuring that consequents emitted from that speaker cannot be heard by any audience member in the theater before the corresponding precedent is heard from its speaker (or speaker group). This arrangement offers the advantage of minimizing the delay imposed on consequents, but requires that each consequent be explicitly associated with its corresponding precedent.

The soundtrack authoring tool of FIG. 4A, which manages each sound object 1-10 separately to provide individual channels for each audio element 401-411 in the timeline, has great utility. However, the resulting soundtrack produced by the tool may exceed the real-time capabilities of the rendering tool (described hereinafter with respect to FIG. 6) for rendering the soundtrack in connection exhibition of the movie in the theater 200, or rendering the soundtrack in the mixing auditorium 100. The term “rendering” when used in connection with the soundtrack, refers to reproduction of the sound (audio) elements in the soundtrack through the various speakers, including delaying consequent sounds as discussed above. For example, a constraint could exist as to the number of allowable channels or sound objects being managed simultaneously. In such circumstances, the soundtrack authoring tool can provide a compact representation 450, shown in FIG. 4B, having a reduced number of channels 1b-7b (the rows of column 470) and/or a reduced number of sound objects (objects 1b-7b in column 471). The compact representation shown in FIG. 4B associates a single channel with each sound object. The individual audio elements 401-411 undergo compacting as the audio elements 451-460 to reduce the use of channels and/or audio objects. For example, music and ambiance audio elements 401 and 402 become audio elements 451 and 452, respectively, because each spans the full length of the scene 300 of FIG. 3 and offers no opportunity for further compaction. Each audio element still occupies the original number of channels, and in this embodiment, each still corresponds to the same sound object (now re-named as object 1b/2b).

A different situation occurs for the engine noise 322 and the screech 325, previously provided as the distinct audio elements 403 and 404 on separate channels 3 and 4, respectively, associated with discrete objects 3 and 4, respectively. These sounds do not overlap along timeline 424 and thus can be consolidated to the single channel 3b associated with object 3b whose dynamic position through the timeline 474 corresponds to that for the engine noise 322 during at least the interval corresponding to the audio element 453 in the timeline and subsequently to that for the screech 325 during at least the interval corresponding to audio element 454. Consolidated audio elements 453 and 454 can have annotations indicating their origins in the mixing session 400 of FIG. 4A. The annotations for the audio elements 453 and 454 will identify the original object #3 and object #4, respectively, thereby providing a clue for at least partially recovering the mixing session 400 from the consolidated immersive soundtrack representation 450. Note that a gap exists between the audio elements 453 and 454 sufficient to accommodate any offset in the timeline position as might be applied to a consequent sound, though in this example, neither audio element 453 or 454 is a consequent.

Likewise, the warning shout 331 and gunshot 341, previously provided as the distinct audio elements 408 and 405, respectively, on channels 8 and 5, respectively, associated with discrete objects 8 and 5, respectively, can undergo consolidation into common channel 4b and object 4b, respectively. Again, each of the audio elements 408 and 405 will typically have an annotation indicating their original object designation. The annotation could also reflect a channel association (not shown, only the original associations to object 8 and object 5 are shown). As with the consolidated channel 3b, the audio elements associated with the channel 4b do not overlap and maintain sufficient clearance in case the sound engineer had designated one or the other sound element as a consequent sound (again, not the case in this example).

In the case of the echo of the warning shout 331 and the echo of the gunshot 341 (both of FIG. 3), each will have a designation as a consequent sound by metadata (e.g., metadata 476) associated with the audio element (e.g., audio element 456), corresponding to the indication (e.g., checkbox 426) in the user interface of mixing session 400. The ricochet 350 represented by audio element 407 has no location for consolidation in channels 1b-5b, since the audio element representing the ricochet overlaps at least one audio element (e.g., one of audio elements 451, 452, 453, 455, and 456) in each of those channels and does not have a substantially similar object position. For this reason, the ricochet 350, which corresponds to the audio element 457 on channel 6b associated with object 6b, will have associated metadata 477 designating this sound as a consequent sound, on the basis of indication provided in the checkbox 427.

The taunt 361 and its echo, previously treated as separate channels 10 and 11 were assigned to the same object 10, since they emanate from similar directions 362 and 363 in FIG. 3. In the consolidated format 450 of FIG. 4B, the sound engineer will mix the discrete audio elements 410 and 411 into a single audio element 460 corresponding to channel 7b assigned to object 7b. Even though audio element 460 does not substantially overlap the object 455, in this embodiment, further consolidation of audio element 460 onto channel 4b does not occur, in case an object is marked as a consequent sound, or in case of concern regarding how quickly the real-time rendering tool, described with respect to FIG. 6, can jump discontinuously from one position (as for the gunshot 341) to another (as for the taunt 361). Note here that even though recovery of the original common association with object #10 remains possible, separating this mixed track into the original discrete audio elements 410, 411 cannot occur. Thus, in some embodiments, the mixing session 400 illustrated in FIG. 4A would be saved in an uncompressed format, substantially corresponding to the channels, objects, audio elements, and metadata (e.g., checkboxes 422) shown there, and either that uncompressed format, or the compressed format represented in FIG. 4B could be used in a distribution package sent to theaters.

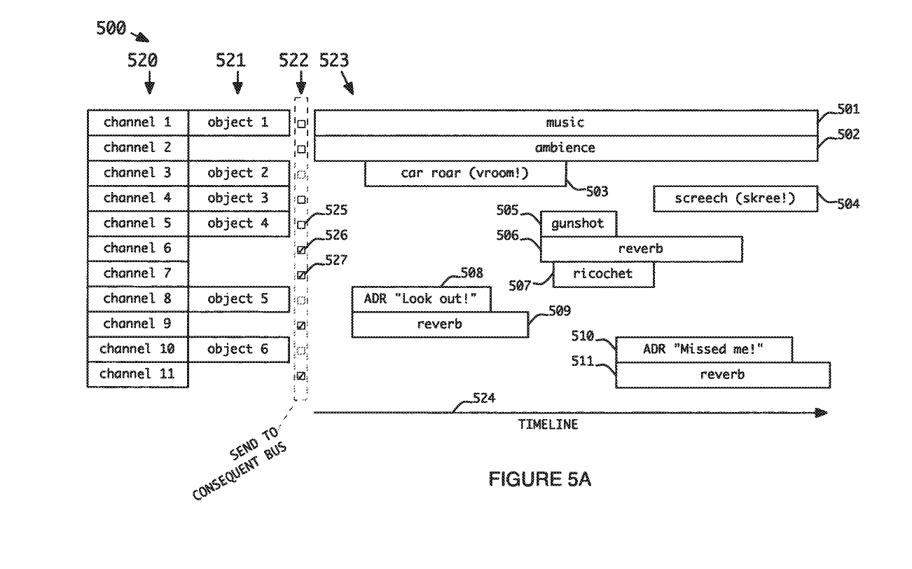

FIG. 5A shows a different user interface an authoring tool for a mixing session 500, which uses a paradigm in which consequent sounds appear on a common bus and not individually localized. Thus, for example, the echo of the gunshot 341 emanates from many speakers in the venue, not just those substantially corresponding to the direction 344. During the mixing session 500 of FIG. 5A, as during the mixing session 400 of FIG. 4A, each of the audio elements 501-511 appears on a discrete one of the channels 1-11 in column 520 and lies along timeline 524. However, since only some of the sounds become localized, not every channel has an association with a corresponding one of the sound objects 1-6 in column 521. As before, each audio element can have a designation as a consequent sound or not (column 522), as indicated by checkboxes being marked (e.g., checkbox 526), or unmarked (e.g., checkbox 525).

In the case of the audio element 501 for music on the channel 1, the association with object 1 can serve to present the score in stereo or otherwise present the score with a particular position. In contrast, the ambience element 502 on channel 2 has no association with an object and the rendering tool can interpret this element during playout as a non-directional sound, e.g., coming from all speakers, or all speakers not behind the screen, or another group of speakers predetermined for use when rendering non-directional sounds.

Referring to FIG. 5A, the engine noise 322, screech 325, gunshot 341, warning shout 331, and taunt 361 (all of FIG. 3) comprise audio elements 503, 504, 505, 508, and 510, respectively, on channels 3, 4, 5, 8, and 10, respectively, associated with sound objects 2, 3, 4, 5, and 6, respectively. These sounds constitute the non-consequent sounds and the authoring tool will handle these sounds in a manner similar to that described with respect to FIG. 4A.

However, the authoring tool of FIG. 5A will handle differently the echo of gunshot 341, the ricochet 350, the echo of warning shout 331 and the echo of taunt 361, on channels 6, 7, 9, and 11, respectively. Each of these sounds is tagged as a consequent sound (e.g., by the sound engineer marking the checkboxes 526 and 527). As a result, the rendering tool will delay each of corresponding audio element 506, 507, 509, and 511 according the δd predetermined for the venue (e.g., mixing stage 100 of FIG. 1 or theater 200) in which the soundtrack undergoes playout. Even though the rendering tool will render channels 6, 7, 9, and 11 according to the same non-directional method as the ambience channel 2, the ambience audio element 502 does not constitute a consequent sound and need not experience any delay.

Thus, in the compact representation 550 with the consequent bus, as shown in FIG. 5B, the addition of an ambient handling assignment 574 and consequent bus handling assignment 575, both in column 571, can accomplish a further reduction in the number of discrete channels 1b-5b in column 570 and sound objects 1b-3b in column 571. Here, the audio elements retain their arrangement 573 along timeline 524. For example, the music score audio element 551 appears on channel 1b in association with object 1b in column 571 for localizing the score during a performance. The ambience element 552 on the channel 2b will playout non-directionally, as described above, by ambient handling assignment 574 (e.g., to indicate that playout will occur played on a predetermined portion of the speakers in the performance auditorium used for non-directional audio).

The authoring tool of FIG. 5B can compact the engine noise 322 and taunt 361 to channel 3b in column 570, with both assigned to object 2b, which takes the location appropriate to the engine noise 322 for at least the duration of the audio element 553. Thereafter, the object 2b takes the location appropriate to the taunt 361 for at least the duration of the audio element 560. Note that the audio elements selected for compacting to a common channel in the representation 550 of FIG. 5B may differ from those selected in the representation 450 of FIG. 4B. Similarly, the authoring tool can compact the warning shout 331, the gunshot 341, and the screech 325 as the audio elements 558, 555, and 554, respectively, on the channel 4b in the column 570 assigned to the object 3b in column 571. These sounds do not overlap along timeline 524, thus allowing the object 3b adequate time to switch to its respective position in scene 300 without issue.

Channel 5b in the compact representation 550 of FIG. 5B has a consequent handling designation 575. As such, the audio from channel 5b will receive the same treatment, for the purposes of localization, as the ambient channel 2b. In other words, the audio rendering tool will send such audio to a predetermined group of speakers for reproduction in a non-directional way. Like channel 2b, the consequent bus channel 5b can have a single audio element 576, comprising a mix of the individual audio elements 506, 507, 509, and 511 from FIG. 5A (corresponding to the audio elements 556, 557, 561, and 559, respectively, in shown in FIG. 5B). Note that even though the audio elements 556, 557, and 561 overlap along the timeline 524, since the sound engineer has designated then as consequents (e.g., by marking the checkbox 526), these consequent sounds undergo non-directional reproduction. Only a single audio element 576 remains necessary for the representation of these consequent sounds.

For a performance in a venue (e.g., the mixing stage 100 of FIG. 1 or the theater 200 of FIG. 2), the rendering tool, whether real-time or otherwise, will delay consequent bus audio element 576 on channel 5b relative to the other audio channels 1b-4b by an amount of time based on to the predetermined δd for the venue. Using this mechanism, no audience member, regardless of his or her seat, will hear a consequent sound in advance of the corresponding precedent sound. Thus, the position of the precedent sound in the immersive soundtrack remains preserved against the adverse psychoacoustic Haas effect that δd might otherwise induce among audience members seated in a portion of the venue furthest most away from the speakers reproducing the a directional precedent sound.

The compact representation 450 of FIG. 4B may have greater suitability for theatrical presentations. The more compact representation 550 of FIG. 5B, while still suitable for theatrical presentations, could have applicability for consumer use, because of this compact representation imposes less demands for sound object processing. In some embodiments, a hybrid approach will prove useful, wherein an operator (e.g., a sound engineer) can designate some consequent sounds as non-directional, for example with an additional non-directional checkbox (not shown) in the user interface 500 of FIG. 5A.

In FIGS. 5A and 5B, some channels will not have any association with an object in column 521 or 571. However, these channels still have an association with a sound object, just not one that provides localization using the immersive, 2D or 3D spatial coordinate systems suggested above. As described, these sound objects (e.g., channel 2 and audio element 502) have an ambient behavior. The channels sent to the consequent bus will have an ambient behavior that includes the delay corresponding to the δd appropriate to the venue when the motion picture presentation occurs. As discussed previously, the object 1 associated with music element 401 of FIG. 4A (or similarly, music element 501 of FIG. 5A) could have a static setting for mapping a stereo audio element to specific speakers in the venue (e.g., the leftmost and rightmost speakers behind the screen). Likewise, there could exist sound objects (not shown) having audio elements mapped to specific speaker groups, such as the left-side surround speakers or overhead speakers 104/204. Use of any of these simplified mappings can occur independently or in conjunction with the immersive (2D or 3D positioned) objects, and any of these simplified mappings can apply with the consequent indicators.

FIG. 6 depicts a flowchart illustrating the steps of an immersive sound presentation process 600, in accordance with the present principles, for managing reverberant sounds, which comprises two parts: The first part comprises an authoring portion 610 representing an authoring tool; and the second part comprises, a rendering portion 620, representing a rendering tool either in real-time or otherwise. A communications protocol 631 manages the transition between the authoring and rendering portions 610 and 620, as might occur during a real-time or near real-time editing session, or with a distribution package 630, as used for distribution to an exhibition venue. Typically, the steps of the authoring portion 610 of process 600 undergo execution on a personal or workstation computer (not shown) while the steps of the rendering portion 620 are performed by an audio processor (not shown) the output of which drives amplifiers and the like for the various speakers in the manner described hereinafter.

The improved immersive sound presentation process 600 begins upon execution during step 611, whereupon, the authoring tool 610 arranges the appropriate audio elements for a soundtrack along a timeline (e.g., audio elements 401-411 along the timeline 424 of FIG. 4A). During step 612, the authoring tool, in response to user input, assigns a first audio element (e.g., audio element 405 for gunshot 341) to a first sound object (e.g., object 5 in column 421). During step 613, the authoring tool assigns a first position (e.g., azimuth=−140°, i.e., along line 343), or a first trajectory over time, to the first object.

During step 614, the authoring tool, in accordance with user input, assigns a second audio element (e.g., 406 for the echo of gunshot 341) to a second sound object (e.g., object 5 in column 421). During step 615, the authoring tool assigns a second position (e.g., azimuth=150°, i.e. along line 344), or a second trajectory over time, to the second object.

During step 616, the authoring tool determines whether the second audio (e.g., 406) element constitutes a consequent sound, in this case, of the first audio element (e.g., 405). The authoring tool can make that determination automatically from a predetermined relationship between channels 5 and 6 in column 420 (e.g., channel 6 represents a sound effect return derived from a sound sent from channel 5), in which case the first and second audio elements will have a relationship as precedent and consequent sounds, as known a priori. The authoring tool could also automatically identify one sound as a consequent of the other by examining the audio sounds and finding that a sound on one track has a high correlation to a sound on another track.

Alternatively, the authoring tool can make a determination whether the sound constitutes a consequent sound based on the indication manually entered by the sound engineer operating the authoring tool, e.g., when the sound engineer marks 426 in the user interface for mixing session 400 to designate that the second sound element 406 constitutes a consequent sound element, though the manual indication need not specifically identify the corresponding precedent sound. In still another alternative, the authoring tool could tag audio element 406 to designate that audio element as a sound effect return derived from another channel, which may or may not specify that sound element's precedent sound. The results of that determination can appear in the user interface (e.g., by a marked checkbox 426 of FIG. 4A or checkbox 526 in FIG. 5A) for storage in the form of a consequent metadata flag 476 associated with audio element 456 of FIG. 4B or, alternatively, to cause audio element 506 to be mixed to the consequent bus 575 as component 556 as in FIG. 5B.

During step 617 of FIG. 6, the authoring tool 610 will encode the first and second audio objects. In this example, with respect to FIGS. 4A and 4B, this encoding takes objects 5 and 6 in column 421 of FIG. 4A, including the assigned first and second audio elements 405 and 406, together with the metadata for the first and second object positions (or trajectories) and the consequent metadata flag 426. The authoring tool encodes these items into communication protocol 631 or distribution package 630, for transmission to the rendering tool 620. This encoding may remain uncompacted, having a representation directly analogous to information as presented in the user interface of FIG. 4A, or could be more compactly represented as in the example representation of FIG. 4B.

With respect to the alternative example of FIGS. 5A and 5B, during step 617 the authoring tool encodes first object 4 in column 521 of FIG. 5A, including the assigned audio element 505 together with the metadata for the corresponding position (or trajectory). For the encoding of the second object (comprising the echo of gunshot 341), this includes the assigned audio element 506 and the “ambient” localization prescribed for the consequent bus object 575 of FIG. 5B, with which, by the determination of step 616 (indicated by mark 526), channel 6 of column 520 and corresponding audio element 506 becomes a component. This results in the consequent bus object 575 having audio element 576, which comprises component audio element 556 derived (i.e., mixed) from audio element 506. In this alternative, too, the authoring tool encodes these items into communication protocol 631 or distribution package 630, for transmission to the rendering tool 620. This encoding may remain uncompacted, having a representation directly analogous to information as presented in the user interface of FIG. 5A (i.e., where the component audio elements assigned to the consequent bus object are not yet mixed), or could be more compactly represented as in the example representation of FIG. 5B (i.e., where the component audio elements assigned to the consequent bus object are mixed to make composite audio element 576.

The rendering tool 620 commences operation upon execution of step 621, wherein the rendering tool receives the sound objects and metadata in the communication protocol 631 or in the distribution package 630. During step 622, the rendering tool maps (e.g., “pans”) each sound object to one or more speakers in the venue where the motion picture presentation occurs (e.g., the mixing stage 100 of FIG. 1 or theater 200 of FIG. 2). In one embodiment, the mapping depends on the metadata describing the sound object, which can include the position, whether 2D or 3D, and whether the sound object remains static or changes over time. In the same or different embodiments, the rendering tool will map a particular sound object in a predetermined manner based on a convention or standard. In the same or different embodiments, the mapping could depend on metadata, but based on conventional speaker groupings, rather than a 2D or 3D position (e.g., the metadata might indicate a sound object for a speaker group assigned to non-direction ambience, or a speaker group designated as “left side surrounds”). During the mapping step 622, the rendering tool will determine which speakers will reproduce the corresponding audio element, and at what amplitude.

During step 623, the rendering tool determines whether the sound object constitutes a consequent sound (that is, the sound object is predetermined to be a consequent sound, as with the consequent bus, or has a tag, e.g., 476 in FIG. 4B, identifying it as such). If so, then during step 624, the rendering tool determines a delay based on predetermined information about the particular venue in which reproduction of the soundtrack will occur (e.g., mixing stage 100 of FIG. 1 vs. theater 200 of FIG. 2). In an embodiment in which the venue is characterized with a single, worst-case differential distance (e.g., δd_{M} or δd_{E}), the Rendering tool will apply the corresponding delay to the playback of the audio element associated with the consequent sound object. Note that this does not affect other untagged (non-consequent) sounds mapped to the same speaker(s). In another embodiment, where the venue is characterized with a worst-case differential distance corresponding to a particular speaker or speaker group (e.g., speakers on the left wall), then the rendering tool will delay a consequent sound object mapped to the particular speaker(s) in accordance with the corresponding worst-case differential distance.

In still another embodiment, in which the venue is characterized with a worst-case differential distance corresponding to each speaker (or speaker group) in the venue with respect to other speakers (or speaker groups). For example, the worst-case differential distance could correspond to the distance between the left-wall speaker group and the right-column of ceiling speakers 204 in the theater 200 of FIG. 2. Note that such a worst-case differential distance is not necessarily reflexive. A seat that allows an audience member to hear the ceiling speaker 204 on the right half of the theater 200 as far in advance as possible with respect to any speaker 203 on the left wall produces a worst-case differential distance. However, that value need not be the same as for a different seat that allows an audience member to hear a left wall speaker as far in advance as possible with respect to the right-half ceiling speakers. To take advantage of such a comprehensive venue characterization, the metadata for a consequent sound object must further include identification of the corresponding precedent sound object. With this information available, the rendering tool can apply a delay to the consequent sound during step 624 based on the worst-case differential distance for the speaker mapped to the consequent sound with respect to the speaker mapped to the corresponding precedent.

During step 625, the rendering tool processes the undelayed non-consequent sound objects and consequent sound objects with accordance with the delay applied during step 624, so that the signal produced to drive any particular speaker will comprise the sum (or weighted sum) of the sound objects mapped to that speaker. Note that some authors discuss the mapping of sound objects into the collection of speaker as a collection of gains, which may have a continuous range [0.0, 1.0] or may allow only discrete values (e.g., 0.0 or 1.0). Some panning formulae attempt to place the apparent source of a sound between two or three speakers by applying a non-zero, but less than full gain (i.e., 0.0<gain<1.0) with respect to each of the two or three speakers, wherein the gains need not be equal. Many panning formulae will set the gains for other speakers to zero, though if a sound is to be perceived as diffuse, this might not be the case. The immersive sound presentation process concludes following execution of step 627.

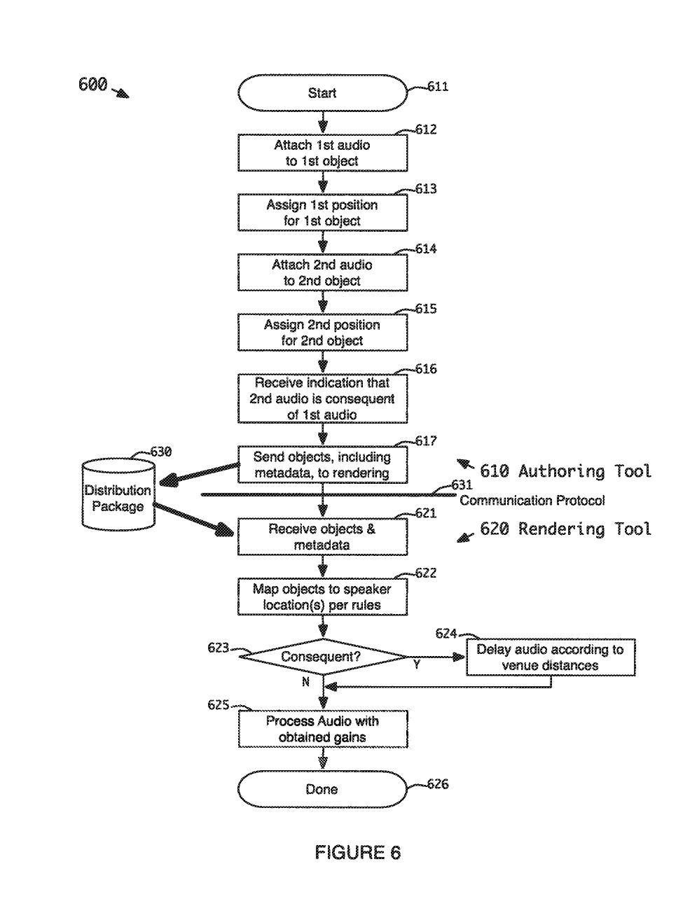

FIG. 7 depicts an exemplary portion 700 of a motion picture composition comprising a sequence of pictures 711 along a timeline 701, typically arranged as data sequence 710 (which could comprise a signal or a file), as might be used during authoring portion 600 of FIG. 6. In most systems, an edit unit 702 corresponds the interval for a single frame, so encoding of all other components of the composition (e.g., the audio, metadata, and other elements not herein discussed) occurs in chunks corresponding to an amount of time that corresponds to the edit unit 702, e.g., 1/24 second for a typical motion picture composition whose pictures are intended to run at 24 frames per second.

In this example, individual pictures in sequence 711 are encoded according to the Key-Length-Value (KLV) protocol, as described in SMPTE standard “336M-2007 Data Encoding Protocol Using Key-Length-Value”. KLV has applicability for encoding for many different kinds of data and can encode both signal streams and files. The “key” field 712 constitutes a specific identifier reserved by the standard to identify image data. Specific identifiers different from that in field 712 serve to identify other kinds of data, as described below. The “length” field 713 immediately following the key describes the length of the image data is, which need not be the same from picture to picture. The “value” field 714 contains the data representing one frame of image. Consecutive frames along timeline 701 each begin with the same key value.

The exemplary portion 700 of the motion picture composition further comprises immersive soundtrack data 720 accompanying the sequence of pictures 711 corresponding to the motion picture comprises digital audio portions 731 and 741 and corresponding metadata 735 and 745, respectively. Both consequent and non-consequent sounds have associated metadata. A paired data value, e.g., data value 730, represents the stored value of a single sound channel, whether independent (e.g., channel 5 in FIG. 4A, column 420) or consolidated (e.g., channel 4b in FIG. 4B, column 470). The paired data value 740 represents the stored value of another sound channel. The ellipsis 739 indicates other audio and metadata pairs otherwise not shown. The immersive soundtrack data 720 likewise lies along the timeline 701, synchronized with the pictures in data 710. The audio data and metadata undergo separation into edit-unit sized chunks. Sound channel data pairs such as 730 can undergo storage as files, or transmitted as signals, according to use.

In this example, encoding of the audio data and metadata into KLV chunks occurs separately. For example, the audio element(s) assigned to channel 1 associated with object 1 of FIG. 4A, in paired data 730, which starts with key field 732 will have a specific identifier different from the key field 712. The audio elements do not constitute an image, and thus have a different identifier, one reserved by the standard to identify audio data). The audio data will also have a length field 733, and an audio data value 734. In this example, given an edit unit duration of 1/24 second and a digital audio sample rate of 48,000 samples per second, and assuming no compression, the value field 734 will have constant size. Thus, the length field 733 will have a constant value throughout the audio data 731. Each chunk of metadata starts with key field 736, which would have a value different than fields 732 and 712. (Unlike for audio and image data, no standard body has yet to reserve an appropriate sound object metadata key field identifier.) Depending upon implementation, the metadata value fields 738 in the metadata 735 may have a consistent or varying size, represented accordingly in length field 737.

The audio data and sound object metadata pair 740, corresponding to object 10 in FIG. 4A, includes audio data 741 comprising a mix of channels 10 and 11 from FIG. 4A, column 420. The key field 742 may use the same key field identifier as field 732, since both encode audio. The length field 743 specifies the size of audio data value 744, which in this example will have the same size, and be constant throughout the audio data 741, as the length field 733, since the parameters of the audio remain the same in the audio data 731 and the audio data 741, even though the resulting sound object includes the two audio elements 510 and 511 mixed together. The identifier in key field 746, like key field 737, identifies the metadata 745 and the length 747 tells the size of metadata value 748, whether constant throughout metadata or not.

In FIG. 7, the edit unit 702 represents the unit of time along timeline 701. The dotted lines ascending up from the arrowheads bounding the edit unit 702 show temporal alignment, not equal size of data. (In practice, the image data in the field 714 typically exceeds in size the aggregate audio data in audio data values 734 and 744, which in turn exceeds in size the metadata in the metadata values 738 and 748, but all represent substantially identical, substantially synchronous intervals of time.)

An uncompacted representation for composition plays a useful role within the authoring tool during authoring process 610, since the representation of the composition should allow for easy editing of individual sound objects, as well as altering volumes. Additionally, the representation of the composition should allow modification of the nature of an audio effect for reverb (e.g., generating an echo of gunshot 341) as well as altering of metadata (e.g., to give a new position or trajectory at a particular time), etc. However, when being passed from the authoring tool to the rendering tool, especially in form of distribution package 630, a different arrangement of the data provided in audio object dataset 720 may prove useful, as suggested by the compacted representations shown in FIGS. 4B and 5B.

FIG. 7 shows an arrangement of data in which each asset (picture, sounds, corresponding metadata) is separately represented: Metadata is separated from audio data, and each audio object is kept separate. This was selected for improved clarity of illustration and discussion, but is contrary to the common practice in the prior art for a soundtrack, for example one having eight channels (left, right, center, low-frequency effects, left-surround, right-surround, hearing-impaired, and descriptive narration), where it is more typical to represent the soundtrack as a single asset having data for each of the audio channels interleaved every edit unit. Those familiar with the more common interleaved arrangement will understand how to modify the representation of FIG. 7 so as to provide an alternative embodiment in which a single audio track comprises a sequence of chunks each of which includes an edit unit of audio data from each channel, interleaved. Likewise, a single metadata track would include chunks, each including an edit unit of metadata for each channel, also interleaved. Not shown in FIG. 7, but also well understood in the art, is a composition playlist (CPL) file, which would be used in distribution package 630 to identify the individual asset track files (e.g., 711, 731, 735, 741, 745, whether discrete as in FIG. 7 or interleaved as just discussed), and specify their relative associations with each other and their relative synchronization (e.g., by identifying the first edit unit to be used in each asset track file).

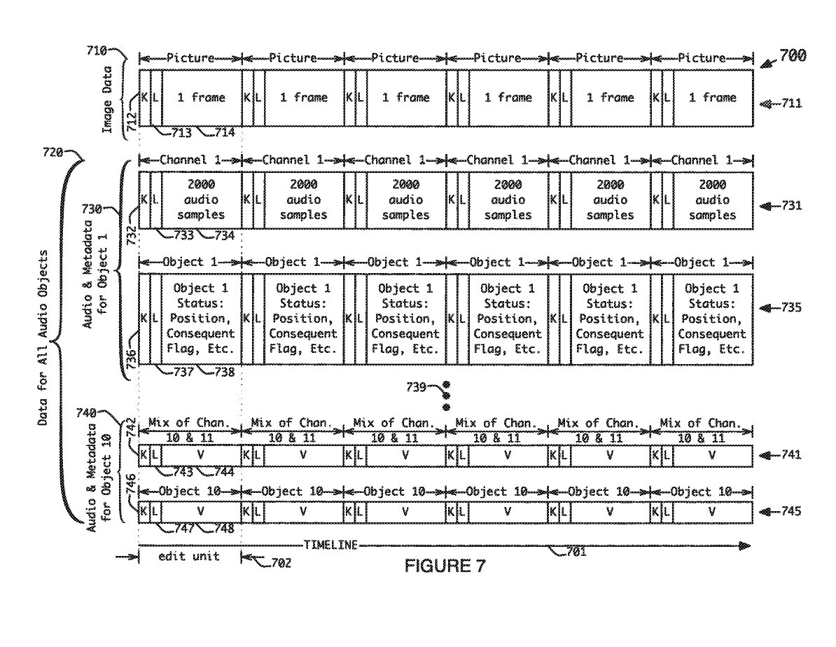

FIG. 8 illustrates another alternative embodiment for data representing audio objects, here provided as a single immersive audio soundtrack data file 820, suitable for delivery to an exhibition theatre, representing the immersive audio track for the exemplary composition. In this embodiment, the format of immersive audio soundtrack data file 820 complies with the SMPTE standard “377-1-2009 Material Exchange Format (MXF)-File Format Specification”, newly applied here to immersive audio soundtrack data. For playout in theaters, the rendering of the immersive soundtrack should interleave the essence (audio and metadata) every edit unit. This greatly streamlines the detailed implementation of the rendering process 620, since a single data stream from the file represents all the necessary information in the order needed, rather than, for example, requiring the system to skip around among the many separate data elements in FIG. 7.

Creation of immersive soundtrack file 820 can proceed by first collecting all the metadata for each sound object in the first edit unit 702 during step 801. Note that the edit unit 702 used in file 820 constitutes the same edit unit used in FIG. 7. In the wrapping for all sound object data (metadata and audio elements) in the first edit unit 802, a new KLV chunk 804 gets assembled, having new key field identifier 803 to indicate that a collection (e.g., an array) of sound object metadata will undergo presentation, the value portion of the chunk 804 consisting of the like-sized value portions (e.g., metadata values 738 and 748) from each of the objects (e.g. object 1-object 10) for the first edit unit. This all-object metadata element 804 precedes the audio channel data corresponding to each of the sound objects and takes the form of KLV chunks copied whole from the digital audio data chunks in the first edit unit during step 805. Thus, key field 732 becomes the first key field seen with its audio data value 734, whereas key field 742 with its audio data value 744 becomes the last field seen.

In this embodiment, the length in all-object metadata element 804 can be used to anticipate the number of individual audio channel elements (e.g., 805) to be presented, and in an alternative embodiment, this number of channels could be allowed to vary over time. In this alternative case, whenever authoring tool 610 determines that there is no audio associated with an object for a particular edit unit (e.g., in FIG. 4A there is no audio associated with any of audio objects 3 through 10 of column 421 from the very beginning of timeline 424 until the beginning of audio elements 408 and 409), then for each such object in each edit unit where the object has no associated audio element, the metadata for that object (e.g., object 10) can be omitted from the all-object metadata element 804 and the corresponding each-object audio element likewise omitted, as it would only contain a representation of silence, anyway. In an immersive audio system that might have the capability of delivering a substantial number of independent sound objects (e.g., 128 of them) in extraordinarily complex scenes, a more typical scene might have fewer than ten simultaneous sound objects, which would otherwise require at least one hundred eighteen channels of silence-representing padding, which amounts to wasted memory. Omitting these objects in such intervals provides an economy that would substantially reduce the size of the distribution package 610. In a further alternative embodiment, the all-object metadata element 804 could always include the maximum possible number of metadata elements and so maintain a constant size, but the metadata for each object (e.g., 738) might further include an indication (not shown) of whether or not that object has fallen silent and accordingly, in the current edit unit has no corresponding each-object audio element (e.g., 805) provided. Since metadata is so much smaller compared with the corresponding audio data, even this further alternative representation would result in substantial savings and can in some ways simplify the processing required to parse the resulting immersive audio track file.

Whether fully populated as shown in the expanded view of 802, or if any metadata and/or audio elements have been omitted for being silent as discussed just above, the wrapped metadata and audio data corresponding to the first edit unit 702, is shown as the more compact composite chunk 802 in the essence container 810. In some embodiments, a further KLV wrapping layer (not shown) may be provided, i.e., by providing an additional key and length at the head of chunk 802, the key corresponding to an identifier for a multi-audio object chunk and the length representative of the size of all-object metadata element 804 aggregated with the size of every each-object audio element 805 present in this edit unit. Each consecutive edit unit of immersive audio likewise gets packaged through edit unit N. According to the MXF standard, and common practice for digital cinema audio distribution, the MXF file 820 comprises a descriptor 822 indicating the kind and structure of the MXF file 820 and, in file footer 822, provides an index table 823 that presents an offset for each edit unit of essence within container 810. That is, an offset exists into the essence container 810 for the first byte of the key field for each consecutive edit unit 702 represented in the container. In this way, a playback system can more easily and quickly access the correct metadata and audio data for any given frame of a movie, even if the size of the chunks (e.g., 802) vary from edit unit to edit unit. Providing the all-object metadata element 804 at the start of each edit unit offers the advantage of making that the sound object metadata immediately available and usable to configure various panning and other algorithms before the audio data (e.g., in chunk 805) undergoes rendering. This allows a best-case setup time for whatever sound localization processing requires.

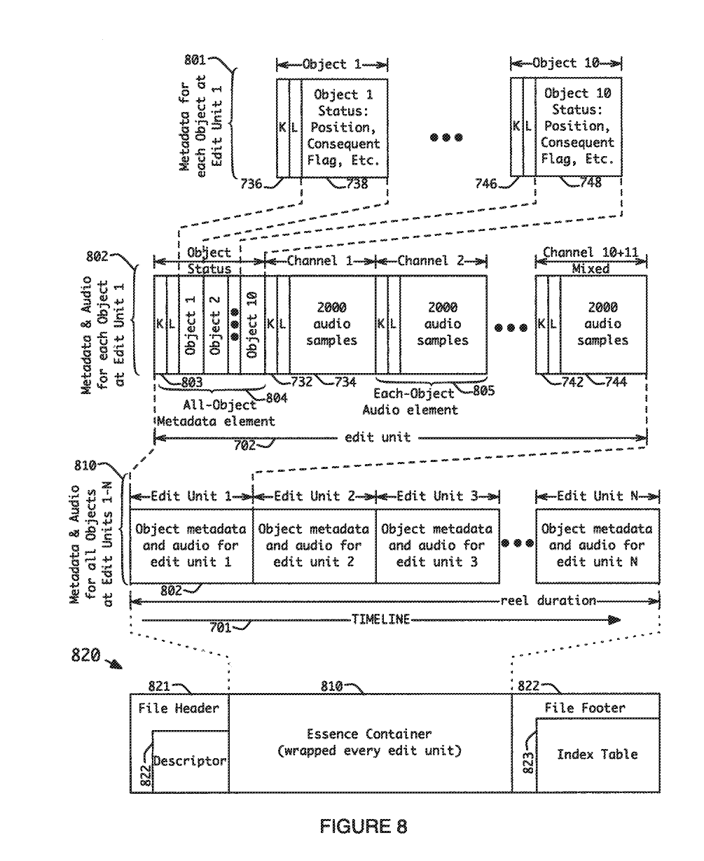

FIG. 9 depicts a simplified floor plan 900 of the mixing stage 100 of FIG. 1 depicting an exemplary trajectory 910 (sequence of positions) in the mixing stage 100 of FIG. 1 for a sound object over the course of an interval of time, which might comprise a single edit unit (e.g., 1/24 second) or a longer duration. Instantaneous positions along the trajectory 910 might be determined according to one of one or more different methods. The simplified floor plan 900 for mixing stage 100 has omitted many details for clarity. The sound engineer sits in the seat 110 while operating the mixing console 120. For the particular interval of interest in the presentation, the sound object should desirably travel along trajectory 910. Thus, the sound should begin at the position 901 at the start of the interval (along azimuth 930), pass through position 902 mid-interval, and then appear at the position 903 (along azimuth 931) just as the interval concludes. The enlarged drawing of the trajectory 910 provides greater detail of the travel of the sound object. The intermediate positions 911-916 depicted in FIG. 9, together with positions 901-903, represent instantaneous positions determined at uniform intervals throughout the interval. In one embodiment, the intermediate positions 911-916 appear as straight-line interpolations between the points 901 and 902, and points 902 and 903. A more sophisticated interpolation might follow the trajectory 910 more smoothly, while a less sophisticated one might perform a straight-line interpolation 920 from position 901 directly to position 903. A still more sophisticated interpolation might consider the mid-interval positions of the next and previous intervals (positions 907 and 905, respectively), for even higher-order smoothing. Such representations provide an economical expression of position metadata over an interval of time, and yet the computational cost for their use is not overwhelming Computation of such intermediate positions as 911-916 could occur at the sample rate of the audio, followed by adjustment of the parameters of the audio mapping (step 622) and processing of the audio accordingly (step 625).

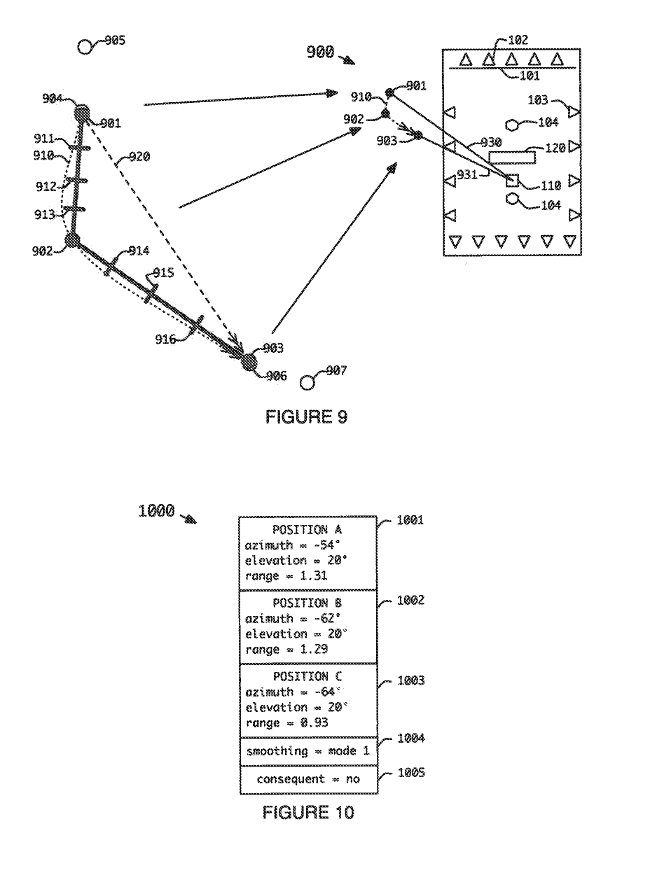

FIG. 10 shows a sound object metadata structure 1000 suitable for carrying the position and consequent metadata for a single sound object for a single interval, which could comprise an edit unit. Thus, with a fixed interval duration of one edit unit, the contents of data structure 1000 could represent sound object metadata values such as 738 and 748. With respect to the sound object prescribed to follow trajectory 910 in FIG. 9, position A is described by the position data 1001, in this example using representation c_{3D}, from above, including an azimuth angle, elevation angle, and range {θ,Φ,r}. For FIG. 9, the convention presumes that unity range corresponds to the distance from the center of the venue (e.g., from seat 110) to the screen (e.g., 101), for the venue under consideration. Apparent range may be used to introduce distance effects (sounds supposedly further away may be less loud than sounds supposedly nearer, or high frequencies may be automatically attenuated for sounds that are substantially further away, etc.), but that is not strictly required. In this example, for this edit unit, position A corresponds to position 901; position B, described by position data 1002, corresponds to position 902; and position C, described by position data 1003, corresponds to position 903. Smoothing mode selector 1004 may select among: (a) static position (e.g., the sound appears at position A throughout); (b) a two-point linear interpolation (e.g., the sound transitions along trajectory 920); (c) a three-point linear interpolation (e.g., to include points 901, 911-913, 902, 914-916, 903); (d) a smoothed trajectory (e.g. along trajectory 910); or (e) a more smoothed trajectory (e.g., where the mid-point 905 and end-point 904 of the metadata for the prior interval is considered when smoothing, as are the start-point 906 and mid-point 907 of the next interval).

Interpolation modes (i.e., the smoothing mode selector 1004) might change from time to time. For example, for object 3b in FIG. 4B, the smoothing mode might be smooth throughout the interval for audio element 453, so that the audience perceives the car engine noise 322 behind them. However, the transition to the start position for the audio element 454 might be discontinuous, before becoming smooth throughout the duration of audio object 454 (for screech 325). Further, different rendering equipment might offer different interpolation (smoothing) modes: For example, the linear interpolation 920 offers greater simplicity than the smooth interpolation along trajectory 910. Thus, an embodiment of the present principles might handle more channels with simpler interpolation, rather than fewer channels with the ability to provide smooth interpolation.

The sound object metadata structure 1000 of FIG. 10 further comprises consequent flag 1005 tested during step 623 of FIG. 6. The Consequent flag 1005 would have the same value through playout of an audio element (e.g., audio element 459), but could change state if followed by a non-consequent audio element (e.g., audio element 455, assuming a modification to FIG. 4B in which audio elements 455 and 456 swap channels).

For some embodiments, not shown in sound object metadata structure 1000, but described above, structure 1000 would further comprise a flag indicating that the corresponding sound object currently has no audio element like 805 and is accordingly silent. This allows a substantial degree of compaction of the resulting asset file 820. In another embodiment, structure 1000 would further comprise an identifier for the corresponding object (e.g., object 1), so that silent objects can be omitted from the metadata in addition to their otherwise silent audio element being omitted, allowing even further compaction, yet still providing adequate information for object mapping at step 622 and audio processing at step 625.

The foregoing describes a technique for presenting audio during exhibition of a motion picture, and more particularly a technique for delaying consequent audio sounds relative to precedent audio sounds in accordance with distances from sound reproducing devices in the auditorium so audience members will hear precedent audio sounds before consequent audio sounds.

1. A method for reproducing in a venue audio sounds in an audio program, comprising the steps of:
examining audio sounds in the audio program to determine which sounds are precedent and which sounds are consequent; and,
reproducing the precedent and consequent audio sounds wherein the consequent audio sounds undergo a delay relative to the precedent audio sounds in accordance with distances from sound reproducing devices in the venue so audience members will hear precedent audio sounds before consequent audio sounds.

2. The method according to claim 1 wherein the step of examining audio sounds includes the step of examining metadata accompanying the audio sounds which identifies the sounds as being precedent or consequent.

3. The method according to claim 1 wherein the step of examining audio sounds includes the step of automatically designating an audio sound as a consequent based on a predetermined relationship to another sound.

4. The method according to claim 1 wherein the reproducing step includes mapping the precedent and consequent sounds to different audio reproducing devices.

5. The method according to claim 4 wherein the step of mapping includes establishing a trajectory for at least one of the precedent and consequent sounds to travel relative to the venue in accordance with the metadata.

6. The method according to claim 4 further including the step of driving each audio reproduction device with a signal generated in accordance with a sum of all sounds mapped to that audio reproduction device.

7. The method according to claim 5 wherein the step of determining a trajectory for each sound includes determining at least a direction in one of Cartesian and polar coordinates.

8. A method for authoring an immersive soundtrack for reproduction in an venue in connection with a motion picture, comprising the steps of:
collecting sounds for inclusion in the immersive soundtrack;
creating metadata for the collected sounds to identify sounds are precedent and consequent; and
arranging the sounds and associated metadata in units in chronological order in accordance with a time when such sounds will undergo reproduction.

9. The method according to claim 8 wherein the metadata is created manually.

10. The method according to claim 9 wherein metadata is created manually by specific designation of which sounds are consequent.

11. The method according to claim 8 wherein the metadata is created automatically in accordance with a predetermined relationship between audio sounds.

12. The method according to claim 8 wherein the metadata includes information for establishing a trajectory for sound to travel in the venue.

13. The method according to claim 12 wherein the information for establishing the trajectory includes at least a direction in one of Cartesian and polar coordinates.

14. The method according to claim 8 further including the step of encoding the arranged sounds and metadata in one of a communication protocol or distribution package.

15. The method according to claim 1 wherein the step of examining audio sounds includes the step of automatically designating an audio sound as a consequent based on a relationship to another sound, the relationship being designated in metadata.

16. The method according to claim 1 further comprising the step of:
producing metadata associated with the sounds to indicate, as a result of the determining step, which sounds are precedent and which sounds are consequent.

17. The method according to claim 16 wherein the step of examining audio sounds includes the step of automatically designating an audio sound as a consequent based on a predetermined relationship to another sound.

18. The method according to claim 16 wherein the step of examining audio sounds includes the step of accepting through a user interface of an authoring tool indications from a user as to which audio sounds are consequent audio sounds.
